(19) United States
(12) Patent Application Publication
(10) Pub. No.: US 2014/0125801 A1
(43) Pub. Date: May 8, 2014

(54) ON-LINE TUNNEL DEFORMATION MONITORING SYSTEM BASED ON IMAGE ANALYSIS AND ITS APPLICATION

(71) Applicant: TONGJI UNIVERSITY, Shanghai (CN)

(72) Inventors: Hehua ZHU, Shanghai (CN); Xuezeng LIU, Shanghai (CN); Yunlong SANG, Shanghai (CN)

(73) Assignee: TONGJI UNIVERSITY, Shanghai (CN)

(21) Appl. No.: 14/155,838

(22) Filed: Jan. 15, 2014

Related U.S. Application Data
(63) Continuation of application No. PCT/CN2012/079896, filed on Aug. 9, 2012.

(30) Foreign Application Priority Data
Mar. 16, 2012 (CN) 201210071452.X

(51) Int. Cl. H04N 7/18

(52) U.S. Cl. CPC H04N 7/183
USPC 348/143

(57) ABSTRACT

An on-line tunnel deformation monitoring system based on image analysis and its application comprises identification points, an IP camera, a central control computer, as well as a transmission network and the application of the system includes the following steps: 1) lay the identification points; 2) the central control computer controls the zoom photography of the IP camera periodically; 3) the IP camera transmits the photos to the central control computer; 4) the central control computer conducts self-adaptive filtering transformation for the photos; 5) the central control computer conducts grayscale threshold transformation; 6) the central control computer conducts image edge detection to obtain the identification points; 7) calculation of the arch crown settlement displacement and the arch springing convergence displacement of the identification points; 8) judge whether the arch crown settlement displacement and the arch springing convergence displacement are both less than the set thresholds, and if they are, return to Step 2), otherwise give an alarm.

### BACKGROUND OF THE INVENTION

1. Technical Field

The present invention relates to relevant technologies of an on-line tunnel deformation monitoring system, and especially to an on-line tunnel deformation monitoring system based on image analysis and its application.

2. Description of Related Art

Currently, in the Mainland, manual field measurement is often adopted for the measurement of tunnel deformation, which is on the one hand of low efficiency, and on the other hand influenced greatly by human factors with big measurement errors and no realization of on-line monitoring or automatic warning.

With the continuous improvement of computer performance, the enhancement of computer image processing performance, the appearance of high-resolution digital products, and the generation of powerful image processing & calculation software, the development and application of the deformation measurement based on digital photography in geotechnical engineering has become possible. The deformation measurement based on digital photography is a measurement technology of obtaining information on digital graphs and digital images through computer analysis and processing based on the digital photos taken by digital cameras. According to whether physical marking points for measurement are arranged in geotechnical engineering structures, the method of measuring deformation with digital cameras can be divided into “identification point method” and “non-identification point method”. At present, most measurement methods belong to “identification point method”.

Since the precision of IP cameras has reached over megapixel with the convenience of remote control, adopting high-definition IP cameras to conduct on-line tunnel deformation, monitoring with the identification point method becomes an easily-implemented on-line tunnel deformation monitoring system. However, the existing on-line tunnel deformation monitoring systems generally have defects such as high realization costs and poor monitoring schedules.

### BRIEF SUMMARY OF THE INVENTION

The aim of the present invention is to overcome the defects in the prior art by providing an on-line tunnel deformation monitoring system based on image analysis and its application with simple implementation, realization of on-line monitoring & automatic warning, as well as function of saving historical on-site photos for retrospective analysis.

The aim of the present invention can be achieved by the following technical solution:

An on-line tunnel deformation monitoring system based on image analysis, characterized in that it comprises identification points, an IP camera, a central control computer and a transmission network, wherein the IP camera points at the identification points and the transmission network is used to connect the IP camera and the central control computer.

The identification points consist of 3 rows and 3 columns in continuous arrangement, wherein the colours of each row from top to bottom are black-white-black, white-black-white, and black-white-black respectively.

The square is a 2 cm×2 cm square.

3 identification points are laid in total at the arch crown and the right and left arch springing points respectively in the same vertical elevation.

The IP camera is perpendicular to the installation elevation of the identification points and fitted with LED fill lamps (white light).

The central control computer includes a photography control module, an image processing module and a monitoring & warning module in sequential connection.

The image processing module conducts edge detection to identify the edge of the identification points and extract the coordinates of the identification point centres via Sobel operator.

The application of an on-line tunnel deformation monitoring system based on image analysis, characterized in that it includes the following steps:

1) Lay the identification points;

2) The central control computer controls the zoom photography of the IP camera periodically;

3) The IP camera transmits the photos to the central control computer;

4) The central control computer conducts self-adaptive filtering transformation for the photos and adjusts the output of the filter according to the local variance of images, wherein the smoothing effect of the filter is weak when the local variance is big and strong when the variance is small.

5) The central control computer conducts grayscale threshold transformation by judging whether the grayscale value of the image pixels are less than the set thresholds, and if it does, set the grayscale value of the pixel as 0, namely black, otherwise set the grayscale value as 225, namely white, so as to obtain the binary image;

6) The central control computer conducts image edge detection to obtain the identification points;

7) Calculation of the arch crown settlement displacement and the arch springing convergence displacement of the identification points;

8) Judge whether the arch crown settlement displacement and the arch springing convergence displacement are both less than the set thresholds, and if they are, return to Step 2), otherwise give an alarm.

The arch crown settlement displacement and the arch springing convergence displacement of the identification points are calculated as below:

According to the edge detection results of 3×3 identification points, calculate the coordinate of the central pixel of the central black grid with the upper left corner of the photo being the origin of coordinates and the horizontal & vertical directions being the X-axis & the Y-axis respectively, then calculate the variation values of the “y” coordinate of the identification point in the two photos taken successively and based on the calibrated parameters of the camera, convert the variation values of the pixel coordinate “y” to the displacement, namely, the arch crown settlement displacement of the tunnel face; for the arch springing convergence displacement, calculate the variation values of the “x” coordinate of the identification points on right-and-left arch springing in the two photos taken successively and based on the calibrated parameters of the camera, convert the variation values of the pixel coordinate “x” to the displacement, namely the right-and-left arch springing convergence displacements of the tunnel face.

Compared with the prior art, the present invention boasts advantages of simple implementation, realization of on-line monitoring & automatic warning, as well as function of saving historical on-site photos for retrospective analysis.

### BRIEF DESCRIPTION OF THE SEVERAL VIEWS OF THE DRAWINGS

FIG. 1 is the work flow of the monitoring system of tunnel deformation;

FIG. 2 is the schematic view of the laying of the identification points;

FIG. 3 is the schematic view of the identification points;

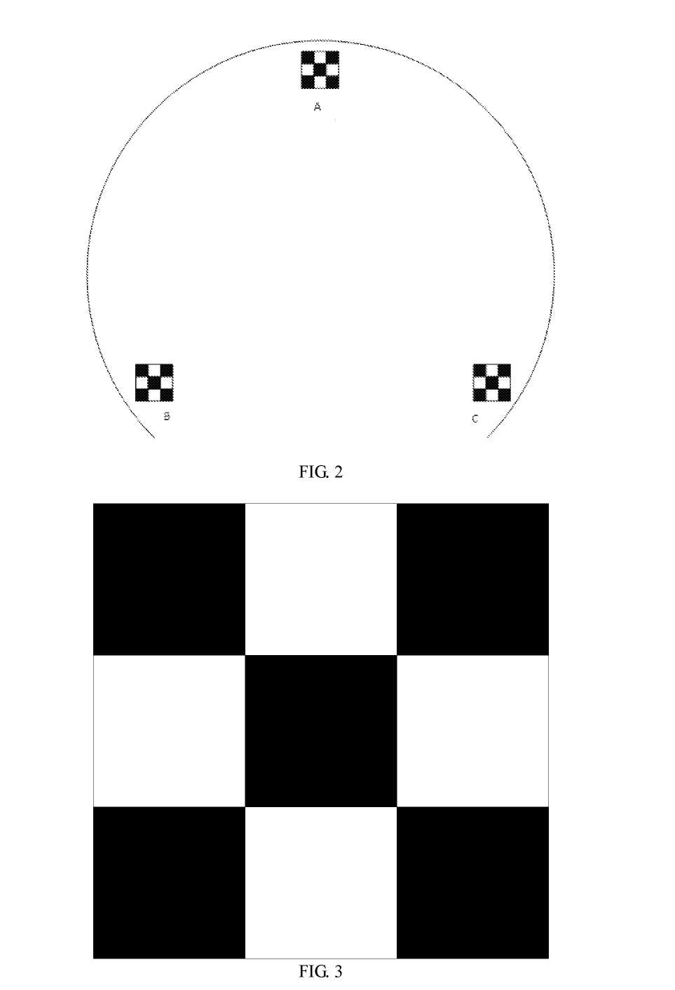

In FIG. 2: “A” is the identification point laid at the arch crown and “B” the identification point laid at the left arch springing, “C” the identification point laid at the right arch springing.

### DETAILED DESCRIPTION OF THE INVENTION

The present invention is detailed in combination with the drawings and the embodiments.

### Embodiments

An on-line tunnel deformation monitoring system based on image analysis, characterized in that it comprises identification points, an IP camera, a central control computer and a transmission network, wherein the identification points is laid such that they point at the installation location of the IP camera and the transmission network is used to connect the IP camera and the central control computer.

As shown in FIG. 2, the identification points consist of 2 cm×2 cm squares with 3 rows and 3 columns in continuous arrangement, wherein the colours of each row from top to bottom are black-white-black, white-black-white, and black-white-black respectively. 3 identification points are laid in total at the arch crown and the right and left arch springing points respectively in the same vertical elevation.

The IP camera is perpendicular to the installation elevation of the identification points and fitted with LED fill lamps (white light). The image resolution of the IP camera is no less than 1.2 million pixels; the installation location of the IP camera is perpendicular to the installation elevation of the identification points as claimed in claim 2; the installation location of the IP camera is 30 m to 50 m away from the tunnel face; the zoom scope of the IP camera lens guarantee that the full screen can shoot 10 m square scenes as well as 1 m square scenes;

The central control computer includes a photography control module, an image processing module, and a monitoring & warning module which are in sequential connection. The image processing module conducts edge detection to identify the edge of the identification points and extract the coordinates of the identification point centres via Sobel operator. The photography control module controls the focusing and photography of the IP camera via the network and saves the photos in the central control computer; the image processing module conducts smoothing treatment and grayscale correction for the saved photos to extract the coordinates of the identification points; the monitoring & warning module compares the coordinates of the identification points with the historical data to realize the monitoring of the arch crown settlement displacement and the arch springing convergence displacement.

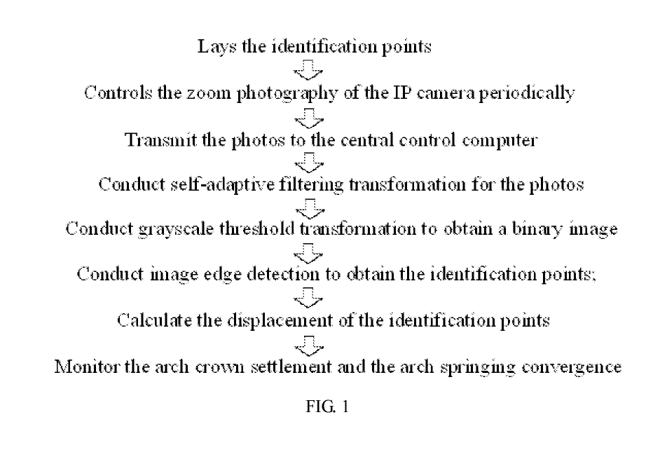

As shown in FIGS. 1 to 3, the application of an on-line tunnel deformation monitoring system based on image analysis, characterized in that it includes the following steps:

1) Lay the identification points as the control points of the photos;

2) The central control computer controls the zoom photography of the IP camera periodically and the IP camera with a pan tilt is installed on the stabilized inner wall of the wall rock of the tunnel;

3) The central control computer controls the transmission of the photos to the central control computer;

4) The central control computer conducts self-adaptive filtering transformation for the photos and adjusts the output of the filter according to the local variance of images, wherein the smoothing effect of the filter is weak when the local variance is big and strong when the variance is small.

5) The central control computer conducts grayscale threshold transformation by judging whether the grayscale values of the image pixels are less than the set thresholds, and if they are, set the grayscale value of the pixel as 0, namely black, otherwise set the grayscale value as 225, namely white, so as to obtain the binary image;

6) The central control computer conducts image edge detection with classical Sobel image edge detection algorithm to obtain the identification points;

7) The calculation of the arch crown settlement displacement and the arch springing convergence displacement of the identification points for deformation data is specifically conducted as below: according to the edge detection results of 3×3 identification points, calculate the coordinate of the central pixel of the central black grid with the upper left corner of the photo being the coordinate origin and the horizontal & vertical directions being the X-axis & the Y-axis respectively, then calculate the variation values of the “y” coordinate of the identification point in the two photos taken successively and based on the calibrated parameters of the camera, convert the variation values of the pixel coordinate “y” to the displacement, namely, the arch crown settlement displacement of the tunnel face; for the arch springing convergence displacement, calculate the variation values of the “x” coordinate of the identification points on right-and-left arch springing in the two photos taken successively and based on the calibrated parameters of the camera, convert the variation values of the pixel coordinate “x” to the displacement, namely the right and left arch springing convergence displacements of the tunnel face;

8) Judge the arch crown settlement and the arch springing convergence to realize real-time monitoring & warning of deformation.

Apply the identification points, the IP camera, and the central control computer to realize real-time analysis and automatic monitoring of the tunnel face deformation. Before taking photos, first lay the identification points on the tunnel face as the control points of the photos and install the IP camera which is connected to the central control computer via the network on the fixed location which will not be deformed with the tunnel face, wherein the control procedure remotely controls the photography of the camera and conducts real-time analysis for the photos, thus realizing automatic monitoring & warning of the tunnel face deformation. First, conduct the laying of the identification points, wherein a plurality of identification points are affixed on the preliminary bracing of the unstable wall rock, and the IP camera with a pan tilt is installed on the stabilized inner wall of the wall rock of the tunnel. Then the camera faces the identification points, takes photos of the tunnel face and transmits the photos to the central control computer. Afterwards, the central control computer conducts analysis and processing for the photos and obtains the deformation data of the tunnel face, thus realizing real-time monitoring & warning of deformation.

1. Image Pre-Processing

In the process of taking photos of the tunnel face, the images obtained are usually unsatisfactory with noise introduced as well as possible underexposure or overexposure of part of the photos during the photography due to environmental influences inside the tunnel such as moisture, dust and poor lighting, at this time, we need to conduct pre-processing for the images such as smoothing treatment and grayscale transformation. The specific operation is as below:

\textcircled{1} Image Transformation

The common image transformation methods include linear transformation, median transformation and self-adaptive filtering transformation, wherein the linear filtering takes its neighborhood S for each image point (m,n) in the given image f(i,j). Assuming that S has M pixels, take the mean value as the grayscale at the image point (m,n) of the processed image. Substitute the mean value of each pixel grayscale within the neighborhood of a pixel for the original grayscale of the pixel, namely, the technology for the neighbourhood averaging. While the median filtering is a non-linear processing method for noise suppression. For the given n values {a1, a2 . . . an}, arrange them in an orderly way by magnitude. When “n” is an odd number, the value located in the middle is called the median of the n values. When “n” is an even number, the mean value of the two values located in the middle is called the median of the n values, and the median filtering means the output of a pixel in the image after filtering equals to the median of the pixel grayscales in the neighborhood of the pixel. Only self-adaptive filtering can realize the self-adaptive filtration of the image noise, which adjusts the output of the filter according to the local variance of the image, wherein the smoothing effect of the filter is weak when the local variance is big and strong when the variance is small. The self-adaptive filtering generally has better effects than the corresponding linear filtering with better selectivity for better saving image edges and high-frequency details. The image edges of the identification points of the 3×3 square vary drastically and other parts of the tunnel face of the photos are relatively gentler, while the purpose of photo processing is to obtain the locations of the identification points, thus the self-adaptive filtering algorithm for image transformation is adopted.

\textcircled{2} Grayscale Transformation

Grayscale transformation can realize the enlargement of dynamic range of images, the extension of contrast ratio and the improvement of image definition which may distinguish the characteristics of images. The common methods comprise grayscale linear transformation, grayscale stretch and grayscale threshold variation, etc.

Grayscale Linear Transformation

The grayscale linear transformation is to transform the grayscale of all points of the image based on the linear grayscale transformation function. When processing the image, take one-dimensional linear function, T(x)=A*x+B, as the transformation function, thus the grayscale transformation equation is:

D_{B}=T(D_{A})=A×D_{A}+B

Wherein parameter A is the slope of the linear function while B the intercept at Y-axis of the linear function, and DA denotes the grayscale of the input image while DB the grayscale of the output image after processing. If A>1, the contrast ratio of the output image will be increased; if A<1, the contrast ratio of the output image will be reduced; if A=1, the output image will be darker or brighter; if A<0, the dark area of the image will be bright and the bright area dark. The values of slope A and intercept B can be input by the user according to actual situation of the image in order that the processed image achieves the expected effects.

Grayscale Stretch

In the same way as the grayscale linear transformation, the grayscale stretch also uses the linear transformation, but the difference lies in that the grayscale stretch does not fully use the linear transformation, but conducts the piecewise linear transformation. The expression of the grayscale transformation function adopted is as below:

$$T ( x ) = \vert \begin{matrix}\frac{{y}_{1}}{{x}_{1}} x & x < {x}_{1} \\ \frac{{y}_{2} - {y}_{1}}{{x}_{2} - {x}_{1}} ( x - {x}_{1} ) + {y}_{1} & {x}_{1} > x > {x}_{2} \\ \frac{255 - {y}_{2}}{255 - {x}_{2}} ( x - {x}_{2} ) + {y}_{2} & x > {x}_{2}\end{matrix}$$

Wherein (x1,y1) and (x2,y2) are the coordinates of the two turning points in the piecewise linear graph, the values input can be defined by the user.

The grayscale stretch can stretch a period of the grayscale interval selectively to improve the output image. If the darkness of an image is caused by grayscale concentration in the darker area, the function can be used to stretch (slope>1) the grayscale interval of the object to make the image bright; on the contrary, if the brightness of the image is caused by grayscale concentration in the brighter area, the function can also be adopted to contract (slope<1) the grayscale interval of the object to improve the image quality.

Greyscale Threshold Transformation

The grayscale threshold transformation can transform a grayscale image into a binary image of black and white. The operation process begins with specifying a threshold by the user, wherein, if the grayscale value of a pixel in the image is less than the threshold, set the grayscale value of the pixel as 0 (black), otherwise set the grayscale value as 255 (white). The transformation function equation of the grayscale threshold transformation is as below:

$$T ( x ) = \vert \begin{matrix}0 & x < T \\ 255 & {x}^{3} T\end{matrix}$$

Wherein T is the threshold specified by the user.

The key of the displacement measurement with “Identification point method” is to correctly identify the coordinates of the identification points, wherein the color of the identification points is required to have high contrast ratio to the color of the background surface, and the coordinates of the identification points are identified by the threshold technology as well as specific algorithm in image processing to analyze the displacement of the identification points for obtaining the deformation displacement of the tunnel face via comparison of coordinate variations at different time of the identification points; for the designed identification points of 3×3 alternating black and white, the grayscale threshold transformation algorithm is taken to achieve the binary image of black and white finally.

2. Image Edge Detection

As one of the important characteristics of images and exhibited mainly in the discontinuity of local characteristics of images, the edge is the place where grayscale varies drastically, namely the commonly-referred place where signals change singularly. The traditional edge detection algorithm is achieved via gradient operators, wherein each pixel location is required to be calculated when evaluating the gradient of edges. In practice, small-area template convolution is usually taken to conduct approximate calculation, wherein the template is the N*N weight matrix and the classical gradient operator templates comprise Sobel template, Kirsch template, Prewitt template, Roberts template and Laplacian template, etc.

In terms of edge positioning ability and noise suppression ability in edge detection, some operators have high edge positioning ability and some are of good anti-noise ability: the Roberts operator searches edges by means of a local difference operator, wherein the edge positioning precision is high while part of the edges are easily to be lost, and the noise suppression ability is lacking due to no calculation of image smoothing. The operator gives best response to low-noise images with cragginess; both Sobel operator and Prewitt operator conduct calculation of difference as well as filtering, but the only contrast is that the weight of smoothing part has some differences, and the two operators have certain noise suppression ability but inadequate ability of excluding the pseudo edges appeared in detection results. With relatively accurate and complete edge positioning, the two operators, however, are easy to have multi-pixel width on the edges. The operators conduct good processing in grayscale gradation and images with noise; Krisch operator conducts detection of the edge information in 8 directions, thus having good edge positioning ability as well as certain noise suppression ability but with a great deal of operand of the operator and unsuitability of real-time detection analysis; Laplacian operator is a second-order differential operator, which conducts accurate positioning of step edge points in images with rotational invariance, namely non-directionality, however, the operator may easily lose the direction information of part of the edges, causing discontinuous detection edges and poor anti-noise ability, thus relatively applicable to roof edges.

Since the image edge of the detected target is a step edge, the model is: f(x)=cl(x), wherein c>0 is the edge amplitude and

$$I ( x ) = \{ \begin{matrix}1 x \geq 0 \\ 0 x < 0\end{matrix}$$

the step function. If existing noise, large-scale images with smoothing template can be selected without affecting the edge positioning.

As self-adaptive filtering is adopted, select a classical Sobel image edge detection algorithm to conduct edge detection for enhancing the efficiency of image analysis and the timeliness of monitoring. The algorithm boasts easy calculation and fast speed, but can only detect the edges in horizontal & vertical directions, thus applicable to images with simple texture. Accordingly, the identification points in the system are designed to be of 3×3 alternating black & white grid while the background image removed early via the grayscale threshold transformation. The basic principle of Sobel algorithm is to take the image points in the neighborhood with grayscale variation beyond an appropriate threshold TH as the edge points due to great brightness variation nearby the image edge.

3. Displacement Calculation of Identification points

According to the edge detection results of 3×3 identification points, calculate the coordinate of the central pixel of the central black grid with the upper left corner of the photo being the origin of coordinates and the horizontal & vertical directions being the X-axis & the Y-axis respectively.

For photo p1, only calculate the variation values of the “y” coordinate of the identification point in the two photos taken successively, and based on the calibrated parameters of the camera, convert the variation values of the pixel “y” coordinate to the displacement, namely the arch crown settlement displacement of the tunnel face.

For photo p2, calculate the variation values of the “x” coordinate of the identification points on the right and left arch springing points in the two photos taken successively, and based on the calibrated parameters of the camera, convert the variation values of the pixel coordinate “x” to the displacement, namely the right and left arch springing convergence displacement of the tunnel face.

What is claimed is:

1. An on-line tunnel deformation monitoring system based on image analysis, wherein comprises identification points, an IP camera, a central control computer, and a transmission network, wherein the IP camera points at the identification points and the transmission network is used to connect the IP camera and the central control computer.

2. The on-line tunnel deformation monitoring system based on image analysis as claimed in claim 1, wherein the identification points consist of 3 rows and 3 columns in continuous arrangement, wherein the colours of each row from top to bottom are black-white-black, white-black-white, and black-white-black respectively.

3. The on-line tunnel deformation monitoring system based on image analysis as claimed in claim 2, wherein the square is a 2 cm×2 cm square.

4. The on-line tunnel deformation monitoring system based on image analysis as claimed in claim 2, wherein 3 identification points are laid in total at the arch crown and the right and left arch springing points respectively in the same vertical elevation.

5. The on-line tunnel deformation monitoring system based on image analysis as claimed in claim 1, wherein the installation location of the IP camera is perpendicular to the installation elevation of the identification points and fitted with a LED fill lamp (white light).

6. The on-line tunnel deformation monitoring system based on image analysis as claimed in claim 1, wherein the central control computer includes a photographing control module, an image processing module, and a monitoring & early warning module in sequential connection.

7. The on-line tunnel deformation monitoring system based on image analysis as claimed in claim 4, wherein the image processing module conducts edge detection to identify the edge of the identification points and extract the coordinates of the identification point centres via Sobel operator.

8. The application of the on-line tunnel deformation monitoring system based on image analysis as claimed in claim 1, wherein it includes the following steps:
1) Lays the identification points;
2) The central control computer controls the zoom photography of the IP camera periodically;
3) The IP camera transmits the photos to the central control computer;
4) The central control computer conducts self-adaptive filtering transformation for the photos;
5) The central control computer conducts grayscale threshold transformation by judging whether the grayscale values of the image pixels are less than the set thresholds; if they are, set the grayscale value of the pixel as 0, namely black, otherwise set the grayscale value as 225, namely white, so as to obtain a binary image;
6) The central control computer conducts image edge detection to obtain the identification points;
7) Calculation of the arch crown settlement displacement and the arch springing convergence displacement of the identification points;
8) Judge whether the arch crown settlement displacement and the arch springing convergence displacement are both less than the set thresholds, and if they are, return to Step 2), otherwise give an alarm.

9. The application of the on-line tunnel deformation monitoring system based on image analysis as claimed in claim 8, wherein the arch crown settlement displacement and the arch springing convergence displacement of the identification points are calculated as below:
According to the edge detection results of 3×3 identification points, calculate the coordinate of the central pixel of the central black grid with the upper left corner of the photo as the origin of coordinates and the horizontal & vertical directions being the X-axis & the Y-axis respectively, then calculate the variation values of the “y” coordinate of the identification point in the two photos taken successively and based on the calibrated parameters of the camera, convert the variation values of the pixel coordinate “y” to the displacement, namely, the arch crown settlement displacement of the tunnel face; for the arch springing convergence displacement, calculate the variation values of the “x” coordinate of the identification points on right-and-left arch springing in the two photos taken successively and based on the calibrated parameters of the camera, convert the variation values of the pixel coordinate “x” to the displacement, namely the right-and-left arch springing convergence displacements of the tunnel face.
